(19) United States
(12) Patent Application Publication
(10) Pub. No.: US 2018/0111568 A1
(43) Pub. Date: Apr. 26, 2018

(54) SUPPORT FOR HOLDING ELECTRONIC DEVICES IN VEHICLES

(71) Applicant: ARTEFACTO PERFECTO, S.L., Barcelona (ES)

(72) Inventors: Fernando José GUIRAO CARTAGENA, Barcelona (ES); Mario ALGUACIL ALGARRADA, Barcelona (ES)

(73) Assignee: ARTEFACTO PERFECTO, S.L., Barcelona (ES)

(21) Appl. No.: 15/567,627

(22) PCT Filed: Jan. 19, 2016
(86) PCT No.: PCT/ES2016/070021

§ 371 Date: Oct. 19, 2017

(30) Foreign Application Priority Data
Apr. 21, 2015 (ES) U201500293

(51) Int. Cl. B60R 11/02

(52) U.S. Cl. CPC B60R 11/02; B60R 2011/0071

(57) ABSTRACT

A support for holding electronic devices in vehicles, with a single piece made of an elastic material which is easily manually deformable such that it can be pressure-fitted between the windscreen and the instrument panel. A cavity is made in the support, the size of said cavity being slightly smaller than that of the electronic device to be held, such that the device is held by pressure.

### FIELD OF APPLICATION OF THE INVENTION

The present invention falls within the scope of supports for fastening portable electronic devices such as mobile phones, browsers, tablets and the like in vehicles.

### BACKGROUND OF THE INVENTION

It is known that there is a wide variety of supports for electronic devices in vehicles. Some of these supports use as fastening mode magnets, others use clamps, etc. However, the most widespread type of support consists of a suction cup, a flexible arm for orienting the device and a rigid piece normally adjustable in width to suit different sizes of devices.

The experience with this type of supports has taught us that they are not a totally effective solution; the vehicle's own movement, vibrations, manipulation of the flexible arm, fog or dirt on the windshield cause the suction cups to lose their fastening capacity, so the functionality of these suction cup-based supports is seriously compromised and ends up falling during its use.

Another improved aspect of the suction cup holders is that said suction cup must be manipulated by the user to fix it on the windshield, this area being too far from the natural reach of the people in many vehicles, forcing them to make uncomfortable efforts and postures during the fixation.

Similarly, in the event of an accident, the existing supports on the market become a danger element for the occupants of the vehicle.

The present invention aims to provide a definitive solution to the fastening of mobile devices in vehicles through a new type of support that can be placed in a simple and fast manner being fully functional in all circumstances.

As an important added value, the invention presented here will never be a danger to anyone in the event of an accident.

### DISCLOSURE OF THE INVENTION

Unlike current fastening devices, composed mainly of several pieces of rigid material, the device described herein is composed solely of a piece or block of elastic material, easily manually deformable.

Said elastic piece or block, will have a cylindrical or prismatic shape and will have on one of its sides a cavity of dimension smaller than a dimension of the object to be held.

The elastic nature of the construction material will serve for, manually pressing, the support to be effectively fitted between the dashboard and the front windshield. The elastic characteristics of the material make it extremely simple to position, orient and remove the support.

The tendency of the elastic material of the support to recover its original shape generates a frictional force on the elements that compress it. In this way, the support is fixed in the position in which it has been placed.

The electronic device is held by the support also exerting a slight manual pressure by placing said device in the cavity realized for that purpose in the support.

Said cavity will have a width slightly smaller than that of the device to be supported adapting and holding it by the pressure that causes the deformation of the material with which the support is constructed.

### BRIEF DESCRIPTION OF THE DRAWINGS

FIG. 1 shows the front view of the support for mobile devices in vehicles (1) in which the cavity to hold the mobile device (2) is seen.

FIG. 2 shows the side view of the support for mobile devices in vehicles (1) in which the cavity to hold the mobile device (2) is seen.

FIG. 3 shows the perspective view of the support for mobile devices in vehicles (1) in which the cavity to hold the mobile device (2) is seen.

FIG. 4 is a side view of the support (1) in its working position, pressure-fitted between the front windshield (A) and the dashboard (B).

Note the deformation in the upper and lower parts of the support (1) produced by the pressure exerted by the windshield (A) and the dashboard (B).

FIG. 5 shows the same elements as FIG. 4, but including the mobile device (3) housed in the support (1), where it is held by the pressure exerted by the cavity on the sides of said device.

FIG. 6 is a perspective view of the support (1) in its working position, pressure-fitted between the front windshield (A) and the dashboard (B).

The deformation produced in the support by the pressure exerted by the windshield (A) and the dashboard (B) can also be observed.

FIG. 7 shows the same elements as FIG. 6, but including the mobile device (3) housed in the support (1), where it is held by the pressure exerted by the cavity on the sides of the device.

### PREFERRED EMBODIMENT OF THE INVENTION

A preferred embodiment consists of a solid one-piece cylindrical support about 12 cm high by 7 cm base, of plastic polyethylene foam material, shaped by injection in a mold.

In the central part of the surface of the cylinder a rectangular cavity of height somewhat smaller than the width of the mobile phone to be fastened and depth somewhat greater than the thickness of the mobile device shall have been practiced.

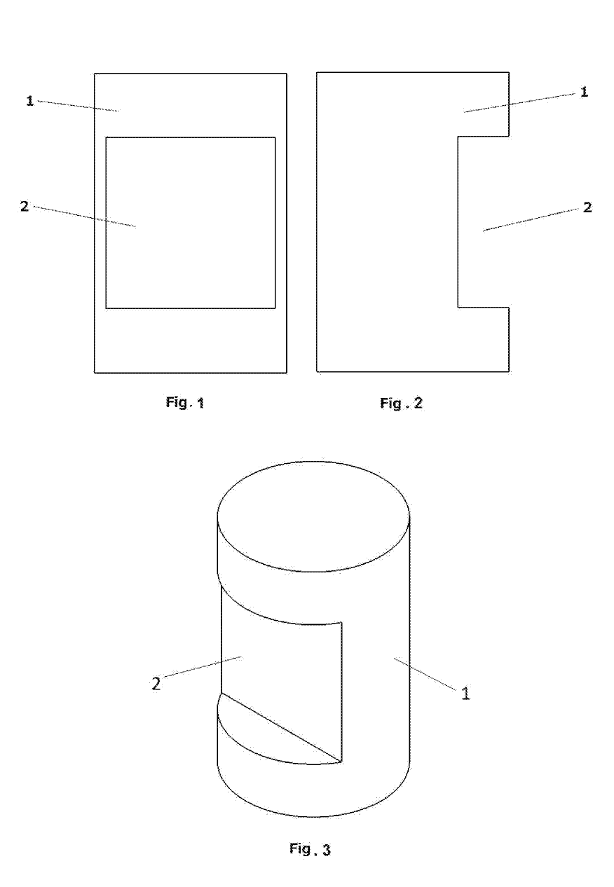

FIGS. 1 to 3 show the elastic cylindrical part constituting the support (1) with the rectangular cavity (2) which will house the electronic device.

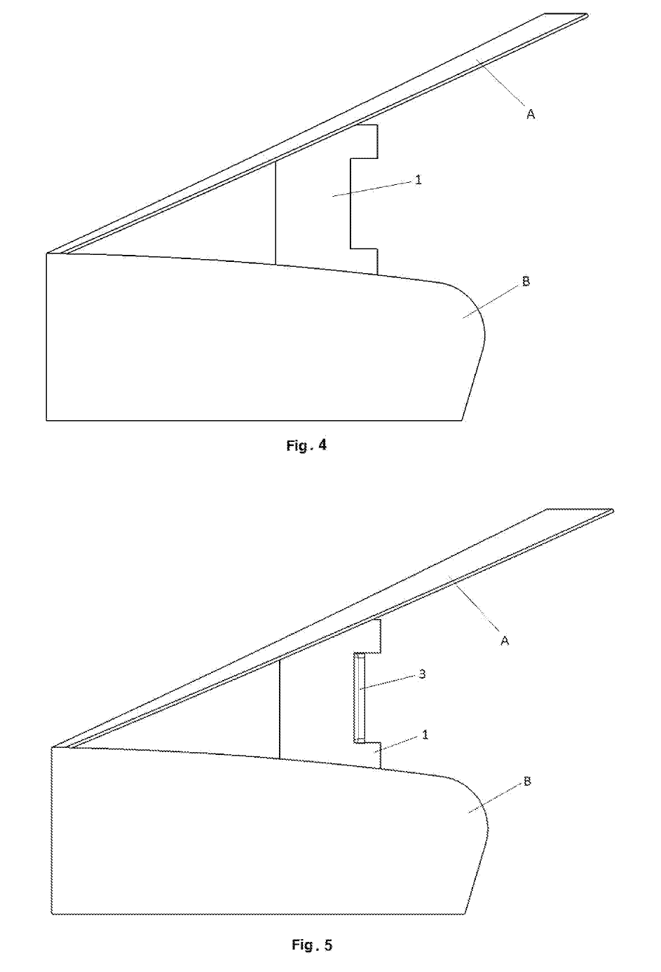

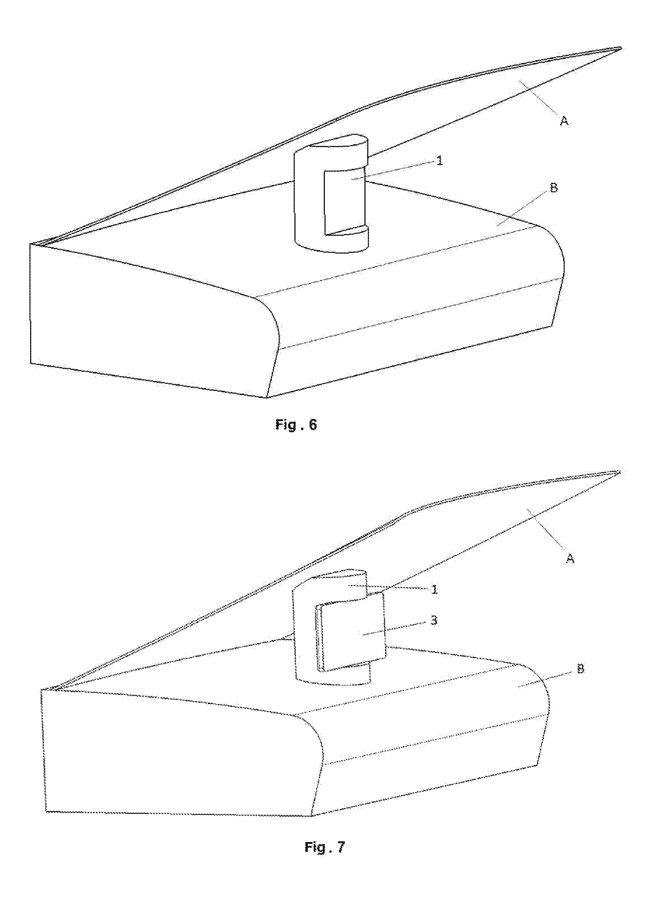

FIGS. 4 to 7 show the support (1) pressed between the front windshield (A) and the dashboard

(B) and holding the electronic device (3) in FIGS. 5 and 7.

1-4. (canceled)

5. A support for holding electronic devices in vehicles, comprising:
a single piece of an elastic material, manually deformable, so as to be able to be pressure-fitted inside the vehicle and further comprising a cavity of a size slightly smaller than the size of the electronic device to be held, such that the device is held by pressure.

6. The support according to claim 5, further comprising: a piece at the top of the support acting as a visor.

7. The support according to claim 5, further comprising more than one surrounding fastening cavity so that the same support can hold a greater variety of mobile devices.

8. The support according to claim 5, wherein the support is formed by two elastic pieces which hold the mobile device at its ends.
